(19) United States
(12) Patent Application Publication
(10) Pub. No.: US 2015/0212226 A1
(43) Pub. Date: Jul. 30, 2015

(54) SYSTEM AND METHOD FOR A DOWNHOLE LOGGING TOOL WITH AN ARRAY OF PAIRED RECEIVER ANTENNAS

(71) Applicant: CNPC USA Corp., Houston, TX (US)

(72) Inventors: Robert C. SMITH, Houston, TX (US); Jianguo LIU, Sugar Land, TX (US)

(73) Assignee: CNPC USA Corp.

(21) Appl. No.: 14/605,840

(22) Filed: Jan. 26, 2015

Related U.S. Application Data
(60) Provisional application No. 61/932,175, filed on Jan. 27, 2014.

(51) Int. Cl. G01V 3/26; G01V 3/38

(52) U.S. Cl. CPC G01V 3/26; G01V 3/38

(57) ABSTRACT

The system for measuring electric resistivity around a borehole includes a tool body having a generally cylindrical shape, at least one transmitter at a first transmitter position on the tool body, an array of receivers on the tool body at a set distance from the first transmitter position, and a processor connected to the transmitter and the array. Each transmitter produces a set of five different measurement combinations with various resolution, coarseness, depth of investigation, and verification with the array. The array includes two pairs of receivers, and each receiver is an antenna, such as a coil in a groove with an antenna shield. The array has innovative placement of each receiver of the two pairs of receivers on the tool body relative to the transmitter for a more complete evaluation of a formation around a borehole.

### RELATED U.S. APPLICATIONS

The present application claims priority under 35 U.S.C. Section 119(e) from U.S. Provisional Patent Application Ser. No. 61/932,175, filed on 27 Jan. 2014, entitled “SYSTEM AND METHOD FOR DOWNHOLE LOGGING TOOL WITH DUAL RECEIVER ANTENNAS”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to induction and propagation logging systems and methods. More particularly, the present invention relates to a resistivity logging tool with dual receiver antennas.

2. Description of Related Art Including Information Disclosed Under 37 CFR 1.97 and 37 CFR 1.98

Electrical resistivity is an inherent property of earth formations. Logging these electrical characteristics of rock and sediment in a borehole assist oil and gas exploration and drilling. Rocks are mostly insulators, and hydrocarbon fluids are also highly resistive. In porous formations, salt water permeates, creating areas of high conductivity and low resistivity. Thus, high resistivity in a formation can indicate presence of hydrocarbons. Resistivity logging records data for evaluating a borehole.

There are other uses for logging while drilling measurements of resistivity. When drilling fluids are used, the resistivity of the formation changes. The permeability of the formation can be determined by reviewing the change in resistivity as the drilling fluids permeate the drilled formation. Water-based mud as a drilling fluid lowers resistivity, while oil-based mud as a drilling fluid increases resistivity. The depth and rate of permeating drilling fluids provide useful data for the evaluation of the borehole and surrounding formation while drilling.

Improving the accuracy and precision of measurements of the dielectric constant or electric permittivity of formations has been the subject matter of existing patents and publications. The basic prior art system includes two receivers and one transmitter. For example, U.S. Pat. No. 4,949,045, issued to Clark et al on Aug. 14, 1990, discloses a multiple receiver system. The transmitter induces current in the formation, and the receivers detect the intensity of this current. The receivers are coil and antenna structures along a tool body of the system. The relative distances between the receivers and the transmitter affect the frequency and intensity of the induced current in the formation. Applied math calculates the electrical resistivity characteristics (dielectric constant and permittivity) of the formation from the transmitter signals and detection by the receivers.

Referring to FIGS. 1 and 2, embodiments of the prior art systems 100 are shown. The system 100 measures electric resistivity around a borehole as an array comprised of transmitters 102 and two receivers 104. The array is positioned on a tool body 106. Each receiver 104 is an antenna comprised of a coil 108 and a shield 110 with a slot 112, which is fitted in a groove 114 on the tool body. The coil 108 detects current in the formation, and the shield 110 and slot 112 are protective structures to maintain the working life of the coil 108. In the prior art, each transmitter 102 corresponds to a set of measurements to each receiver 104. Adding another transmitter adds another set of measurements, wherein two transmitters 102 involve twice as many measurements, and three transmitters 102 involve three times as many measurements, etc. The depth of investigation and resolution is determined by the spacing of the transmitters 102 to the receivers 104.

Systems with multiple receivers are known. U.S. Pat. No. 4,594,551 and US Publication No. 20030229449 describe the structures for three receivers and at least one transmitter. U.S. Pat. No. 3,551,797, issued to Gouilloud et al. on Dec. 29, 1970 and U.S. Pat. No.4,209,747, issued to Huchital on Jun. 24, 1980, discloses systems with two pairs of receivers. Other prior art systems disclose three receivers. Systems with multiple transmitters are also known. U.S. Pat. No. 55,943,437, issued to Clark et al. on Jan. 14, 1997, discloses three different transmitters placed different distances from the pair of receivers.

The applied math to interpret the meaning of different distances between the receivers and transmitters is used to provide the relevant data of dielectric constant, resistivity and/or conductivity of earth formations.

It is an object of the present invention to provide a system with a resistivity logging tool.

It is another object of the present invention to provide an embodiment of the system with a resistivity logging tool with an array of receiver antennas.

It is still another object of the present invention to provide an embodiment of the system with a resistivity logging tool with an increased number of measurements without increasing array length.

It is still another object of the present invention to provide an embodiment of the system with a resistivity logging tool with an array of pairs of receiver antennas.

It is still another object of the present invention to provide an embodiment of the system with a resistivity logging tool with increased depth of investigation measurements.

It is yet another object of the present invention to provide an embodiment of the system with a resistivity logging tool with increased measurement combinations.

It is yet another object of the present invention to provide an embodiment of the system with a resistivity logging tool with verifying measurement combinations.

These and other objectives and advantages of the present invention will become apparent from a reading of the attached specification.

### SUMMARY OF THE INVENTION

Embodiments of the present invention include a system for measuring electric resistivity around a borehole. There is a tool body having a generally cylindrical shape inserted through the wellbore. At least one transmitter means is mounted on the tool body at a first transmitter position, and an array of receiver means is mounted on the tool body at a distance from the transmitter means. There is also a processing means for calculating electric resistivity connected to the transmitter means and the array.

In embodiments of the present invention, distance between the first transmitter position and the array produces a first set of at least five different measurement combinations with receiver means in the array. The single transmitter has five different measurements combinations of various resolution, coarseness, and depth of investigation. In other embodiments, at least one more transmitter means is mounted to the tool body at a second transmitter position. The distance between the second transmitter position and the array produces a second set of five different measurement combinations with the same receiver means in the array. The first transmitter position and the second transmitter position can be symmetrical relative to the array for verify measurements combinations on both sides of the array. The first transmitter position and the second transmitter position can be asymmetrical relative to the array for the second set of five different measurement combinations to have completely different resolution, coarseness, and depth of investigation. Each added transmitter means at an added transmitter position adds another set of five different measurement combinations.

In one embodiment, the array is comprised of a first pair of receiver means mounted on the tool body at a first pair position, and a second pair of receiver means mounted on the tool body at a second pair position. Each receiver means is comprised of at least one antenna. The first pair of receiver means is comprised of a first antenna and a third antenna, and the second pair of receiver means is comprised of a second antenna and a fourth antenna. The first pair position is equidistant between the first antenna and the third antenna. The second pair position is equidistant between the second antenna and the fourth antenna. The antennas detect phase shift or attenuation measurements from the transmitter means.

Embodiments of the present invention include an innovative array of receiving means with particular placement of the first pair and the second pair relative to each other. The distance between the first antenna and the third antenna is less than the distance between the first antenna and the second antenna of the second pair. The antennas in the pair are closer together than an adjacent antenna in another pair. As such, the first antenna is adjacent to the second antenna, the first antenna being between the second antenna and the third antenna, and the second antenna being between the fourth antenna and the first antenna. There are much smaller distances between the receivers for higher resolution of measurements. The smallest possible distance is between antennas in a pair. The array is formed by each pair disposed in a respective groove on the tool body. Separate grooves for antennas are not required, and the innovative array can be installed within the construct of prior art machining. One groove can correspond to a pair of antennas. Some prior art tool bodies may also be retrofit for the system of the present invention for efficiency and simplified construction.

Each set of five measurement combinations has relative distances between antennas and the transmitter means to affect resolution, coarseness, depth investigation, and verification in an innovative manner. One measurement combination is between the first antenna and the second antenna, which can be repeated with increased coarseness between the third antenna and the fourth antenna. Two compensated measurement combinations come from the first antenna and third antenna of the first pair and second antenna and fourth antenna of the second pair. There are also two middle compensated measurements generated from the second antenna and third antenna and from the first antenna and fourth antenna.

The first transmitter position and the array with a first pair position and second pair position are selected for distance between second antenna and third antenna being greater than the distance between the first antenna and second antenna. The distance between the second antenna and the third antenna is also greater than the distance between the first antenna to third antenna and less than the distance between the third antenna to fourth antenna. The distance between the first antenna and the fourth antenna is selected analogous to the distance between the second antenna and the third antenna so that the measurements remain in a backup relationship for verification of each other.

Other embodiments of the present invention include the method measuring electrical resistivity using the system of the at least one transmitter and the array of receivers. The step of selecting the relative position of the receivers in the array interacting with at least one transmitter has particular effects on resolution, coarseness, depth investigation, and verification.

### BRIEF DESCRIPTION OF THE DRAWINGS

FIG. 1 is a schematic view of a prior art resistivity tool system for placement in a wellbore.

FIG. 2 is another schematic view of the prior art resistivity tool system, showing an isolated view of a receiver.

FIG. 3 is a schematic illustration of an embodiment of the system for measuring resistivity around a borehole according to the present invention.

FIG. 4 is another schematic view of the embodiment shown in FIG. 4, showing the array on a tool body with four transmitters.

FIG. 5 is an isolated schematic view of an embodiment of the array of receivers in the system of the present invention.

### DETAILED DESCRIPTION OF THE DRAWINGS

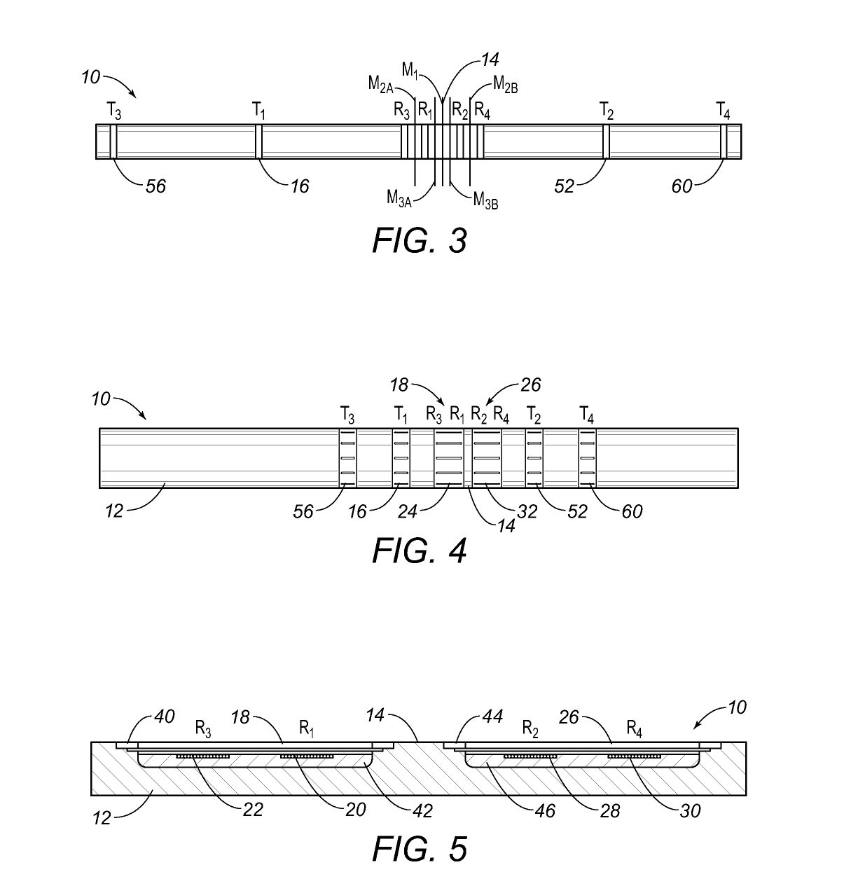

Referring to FIGS. 3-5, embodiments of the system 10 for measuring electric resistivity around a borehole are shown. FIGS. 3-5 have a tool body 12 with a generally cylindrical shape. The tool body 12 is inserted through the wellbore through various delivery methods, including but not limited to the drill string, coiled tubing, and wireline. The tool body 12 can be logging data while drilling or after drilling has been completed. There is at least on transmitter means T1, T2, T3, and T4. FIGS. 3-4 show a first transmitter means T1 is mounted on the tool body 12 at a first transmitter position 16. There is an array 14 of receiver means mounted on the tool body 12 at a distance from the transmitter means T1, T2, T3, and T4. Embodiments also include a processing means (not shown) in communication with the at least one transmitter means T1, T2, T3, and T4, and the array 14 of receiver means, so as to calculate electric resistivity.

In one embodiment, the array is comprised of a first pair 18 of receiver means R1, R3 mounted on the tool body 12 at a first pair position 24, and a second pair 26 of receiver means R2, R4 is mounted on the tool body 12 at a second pair position 32. Each receiver means R1, R2, R3, R4 is comprised of an antenna. FIG. 5 shows the isolated schematic view of one embodiment, according to the present invention. The first pair 18 of receiver means is comprised of a first antenna R1 and a third antenna R3. In FIG. 3, the first pair position M2A is equidistant between the first antenna R1 and the third antenna R3. The second pair 26 of receiver means is comprised of a second antenna R2 and a fourth antenna R4. In FIG. 3, the second pair position M2B is equidistant between the second antenna R2 and the fourth antenna R4. FIG. 5 shows each antenna R1, R2, R3, R4 as a coil 20, 22, 28, 30. The first coil 20 and the third coil 22 share shield 40 with a slot in groove 42. The second coil 28 and the fourth coil 30 share shield 44 with a slot in groove 46. The antennas are paired and share grooves in the tool body 12. The first antenna R1 and the third antenna R3 share groove 42 in the tool body 12. The second antenna R2 and the fourth antenna R4 share groove 46 in the tool body 12. Each antenna R1, R2, R3, R4 detects phase shift or attenuation measurements or both from a transmitter means.

In embodiments of the present invention, distance between the first transmitter position 16 and the array 14 produces a first set of at least five different measurement combinations with receiver means in the array 14. The single transmitter has five different measurements combinations of various resolution, coarseness, and depth of investigation. FIG. 3 shows the schematic illustration of the at least five different measurement combinations, Ml, M2A, M2B, M3A and M3B. Embodiments of the present invention elevate beyond the prior art because the array provides more measurement combinations within the same space and machining on the tool body 12. The innovative array 14 is not disclosed in the prior art, which adds measurements by adding more transmitters. Adding more transmitters or adding more receiver antennas in the prior art require additional grooves and slots on the machining of the tool body 12. In the present invention, each added transmitter adds another set of five different measurement combinations, instead of just adding one additional measurement combination. FIG. 5 shows that the structure of two coils in one groove at a particular placement can create the additional precision and usefulness of the present invention.

FIG. 3 shows the array with the first pair 18 and second pair 26 providing a first measurement combination around M1, set by distance between the first antenna R1 and the second antenna R2 to the transmitter T1. This first measurement has a resolution, coarseness, depth of investigation analogous to prior art systems. However, embodiments of the array 14 of the present invention also provide another level of coarse measurement, set by distance between the third antenna R3 and the fourth antenna R4 to the transmitter T1, which can be taken in addition to the measurements between the first antenna R1 and the second antenna R2 without adding another groove or slot to the array 14 of the system 10. Coarse measurement relative to R1-R2 around M1 by R3-R4 has increased depth investigation and lower resolution. The third antenna R3 and the fourth antenna R4 are the farthest apart so that there is greater depth investigation than the first antenna R1 and the second antenna R2.

Two more measurements at M2A and M2B in FIG. 3 are also based on the arrangement of the first pair 18 and the second pair 26 for two compensated measurement combinations. The compensated measurements have decreased depth investigation and high resolution. The high resolution is useful and necessary for the borehole calibration. These compensated measurements happen at distances set between the antennas in the pairs, such as M2A between the first antenna R1 and the third antenna R3 to the transmitter T1 and M2B between the second antenna R2 and the fourth antenna R4. The first compensated measurement from the first antenna R1 and the third antenna R3 is bolstered and confirmed by the second compensated measurement from the second antenna R2 and the fourth antenna R4. There is a backup and verification for the first compensated measurement. Thus, the M2A and M2B measurement combinations by the array 14 have resolution, coarseness, depth of investigation, and verification beyond the prior art systems and within the same tool body 12 construction.

For the set of at least five different measurement combinations, two more measurements at M3A and M3B in FIG. 3 are also based on the arrangement of the first pair 18 and the second pair 26 for two middle compensated measurement combinations. A first middle compensated measurement relative to prior art has depth investigation between coarse measurements and original measurements and resolution between original measurements and compensated measurements. These middle compensated measurements are set by the distance M3A between the second antenna R2 and third antenna R3 as the differential receivers to the transmitter T1 and the distance M3B between the first antenna R1 and the fourth antenna R4 as the differential receivers to the transmitter T1. The first transmitter position 16, first pair position 24 and second pair position 32 are selected for distance between second antenna R2 and third antenna R3 to be greater than the distance between the first antenna R1 to second antenna R2, greater than the first antenna R1 to third antenna R3, and less than third antenna R3 to fourth antenna R4. For the second middle compensated measurements as the backup and verification, the first transmitter position 16, first pair position 24 and second pair position 32 are selected for distance between first antenna R1 and fourth antenna R4 to be greater than first antenna R1 to second antenna R2, greater than the second antenna R2 to fourth antenna R4, and less than third antenna R3 to fourth antenna R4. Again, the M3A and M3B measurement combinations by the array 14 have resolution, coarseness, depth of investigation, and verification beyond the prior art systems, which simply add another transmitter or another receiver for additional readings, which may or may not be related and which may or may not be verified. The present invention also adds the dimensions within the same tool body 12 construction.

In other embodiments, at least one more transmitter means is mounted to the tool body at a second transmitter position. FIGS. 3-4 show transmitters T2, T3 and T4 at second transmitter position 52, third transmitter position 56, and fourth transmitter position 60, respectively. The distance between the second transmitter position 52 and the array 14 produces a second set of five different measurement combinations with the same receiver means R1, R2, R3, R4 in the array 14. The M1, M2A, M2B, M3A and M3B distances and corresponding receiver combinations can be applied to each transmitter for more levels of resolution, coarseness, depth of investigation and verification. When the first transmitter position 16 and the second transmitter position 52 are symmetrical relative to the array 14, measurements combinations on both sides of the array 14 are mirror images, providing further verification and robust data. The two sets of five different measurement combinations verify each other. When the first transmitter position 16 and the third transmitter position 56 are asymmetrical relative to the array 14, then the set of five different measurement combinations have completely different resolution, coarseness, depth of investigation, and verification. Each added transmitter means at an added transmitter position adds another set of five different measurement combinations.

The embodiments of the array 14 of the present invention includes select placement of the first pair 18 and the second pair 26 relative to each other. The distance between the first antenna R1 and the third antenna R3 is less than the distance between the first antenna R1 and the second antenna R2 of the second pair 26. The antennas in a pair are closer together than an adjacent antenna in another pair. When the first antenna R1 is adjacent the second antenna R2, the first antenna R1 is between the second antenna R2 and the third antenna R3. Similarly, the second antenna R2 is between the fourth antenna R4 and the first antenna R1. The third antenna R3 and the fourth antenna R4 are the farthest apart. In embodiments of the present invention, smaller distances between differential receivers increase resolution, so the antennas closer together have the higher resolution. The smallest possible distance is between antennas in a pair. This short spacing allows for borehole calibration, which depends upon size and diameter of the tool body. Adding more receivers/antennas may violate the short spacing so that borehole calibration would not be possible. Placing three coils in a single slot does not practice the present invention, if the distance between adjacent coils is too close. There is no differential reading, and there is no complementary relationship of the receivers, unlike the relationships of the present invention.

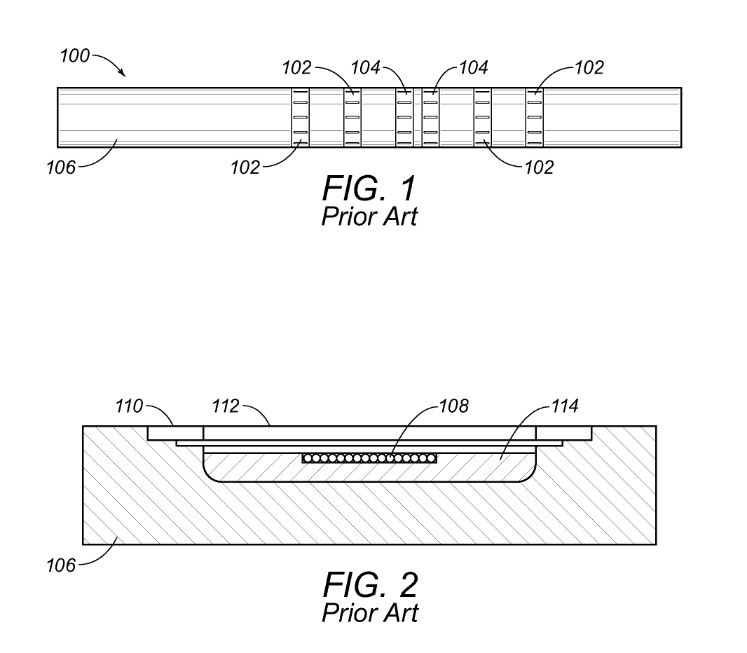

Relative distances between antennas in the present invention affect depth investigation, resolution, and verification of measurements. When the first antenna R1 and the second antenna R2 are the differential receivers, the measurements are analogous to the prior art systems. For example, receivers 104 to any transmitter 102 in FIG. 1 take the same measurements. The depth investigation and resolution of the first antenna R1 and the second antenna R2 are analogous to prior art systems. Additional transmitters are added to increase the number of measurements and data for comparison and precision. Within the embodiments of the array 14, the receivers R1, R2, R3, R4 are placed so that the measurement combinations from M1, M2A, M2B, M3A have meaningful and useful data. For example, the distance between R1 and R3 must be smaller than the distance between R1 and R2, and the distance between R1 and R3 may be varied based on the diameter of the tool body 12. As such, the present invention sets an array 14 for a variety of tools with the same capabilities for the five-fold measurement combinations in an array 14 within the same space as the prior art systems with only one measurement.

Embodiments of the present invention include adding a second transmitter means T2 in FIGS. 3-4 mounted on the tool body 12 at a second transmitter position 52. The second transmitter means T2 is on a side of the first pair 18 and the second pair 26 opposite from the first transmitter means Ti. Symmetry of transmitters is created relative to a midpoint between the first pair 18 and the second pair 26. The processing means can now calculate measurements from the second transmitter means T2 as back up to measurements from the first transmitter means T1. The distances to the antennas are mirror distances to the first transmitter means T1, so that analogous measurements for verification of precision measurements from the first transmitter means T1 are known. Adding a second transmitter T2 in the position as claimed adds five times the amount of data, not double the amount of data of the prior art.

Other embodiments add a third transmitter means T3 mounted on the tool body 12 at a third transmitter position 56 on a same side of the first pair 18 and the second pair 26 as the first transmitter means Ti. The third transmitter means T3 is on an opposite side from the second transmitter means T2. The third transmitter means T3 is further away from the midpoint between the first pair 18 and the second pair 26 than the first transmitter means T1. The greater distance increases depth investigation greater than first transmitter means T1 and second transmitter means T2, although there is less resolution as well. The processing means of the present invention calculates measurements from the third transmitter means T3 with lower resolution and greater depth investigation as measurements from the first transmitter means T1. Adding a third transmitter means T3 at 56 sets a distance to the array 14 for another five times the amount of data, not double or triple the amount of data of the prior art.

Still other embodiments of the present invention add a fourth transmitter T4 on the tool body 12 at a fourth transmitter position 60. The fourth transmitter means T4 can create symmetry across the midpoint between the first pair 18 and the second pair 26. The fourth transmitter means T4 is on a side of the first pair 18 and the second pair 26 opposite from the first transmitter means T1 and third transmitter means T3, while being on the same side as the second transmitter means T2. The symmetry of the selection of the fourth transmitter position 60 allows measurements as backup and verification of the measurements from the third transmitter means T3. The distances to antennas are mirrored to the third transmitter means T3, and the analogous measurements are verification of precision of the third transmitter means T3. Adding a fourth transmitter means T4 at 60 sets another distance to the array for another five times the amount of data, not double or triple or quadruple the amount of data.

The method of the present invention includes assembling a downhole tool by mounting the at least one transmitter T1 on a tool body 12 at the first transmitter position 16, mounting the array 4 comprised of a first pair 18 of receivers on the tool body 12 at a first pair position 24 and a second pair 26 of receivers on the tool body 12 at a second pair position 32, and connecting a processor for calculating electric resistivity. Each receiver is comprised of an antenna, so there are four antennas configured as an array of receivers. The positions of receivers within the array 14 are selected according to various resolution, coarseness, depth investigation, and verification so as to allow for collection of multiple measurements at different levels. The distance within a pair of receivers must be smaller than the distance between receivers of different pairs. The distance between adjacent receivers of different pairs is fixed, while the distance between receivers in a pair may be varied based on the diameter of the tool body. The distance within pairs of receivers must be the same for both pairs. Symmetrical placement of positions of the array relative to the at least one transmitter provides for additional verification measurements since the same distances are replicated by the pair structure of the antennas.

The method of the present invention includes an embodiment of a method of using the system 10 to measure electric resistivity of a formation. A first antenna R1 and a second antenna R2 measure resistivity from a first transmitter T1 at a set depth investigation and resolution determined by the first transmitter position 16, the first pair position 24, and the second pair position 32. The first antenna R1 and the third antenna R3 measure resistivity from a first transmitter T1 at a lower depth investigation and higher resolution determined by the first transmitter position 16, the first pair position 24, and the second pair position 32. The second antenna R2 and the fourth antenna R4 measure resistivity from a first transmitter T1 at a same lower depth investigation and same higher resolution determined by the first transmitter position 16, the first pair position 24, and the second pair position 32, verifying the measurements from the first antenna R1 and the third antenna R3.

Additionally, the third antenna R3 and fourth antenna R4 measure resistivity from a first transmitter T1 at a higher depth investigation and lower resolution determined by the first transmitter position 16, the first pair position 24, and the second pair position 32. The first antenna R1 and fourth antenna R4 measure resistivity from a first transmitter T1 at a middle depth investigation and middle resolution determined by the first transmitter position 16, the first pair position 24, and the second pair position 32. The second antenna R2 and third antenna R3 measure resistivity from a first transmitter T1 at a higher depth investigation and lower resolution determined by the first transmitter position 16, the first pair position 24, and the second pair position 32, verifying the measurements from the first antenna R1 and the fourth antenna R4.

The embodiments of the present invention provide a system with a resistivity logging tool. The system includes an array of dual receiver antennas as pairs of antennas in single groove on the tool body. The array has two sets of paired antennas in a particular relationship to the antenna within the pair, to the antennas outside of the pair, to any transmitter and relative to the tool body. There are increased measurements without increasing array length along the tool body by mounting pairs of antennas in single grooves.

The system with the array of receivers has various resolution, coarseness, depth of investigation and verification, according to the configuration of the array. The depth of investigation of measurements adjusts by placement of the pairs of antennas and selection of differential receivers. There are greater distances between antennas within the array without adjusting the tool body. Similarly, the system can adjust the resolution and coarseness of measurements by placement of the pairs of antennas and selection of differential receivers. There are smaller distances between antennas without adjusting the tool body. There is also a smallest distance maintained for short spacing in borehole calibration and proportional distances relative to the tool body. Additionally, symmetrical configurations in the array can provide verification measurements to bolster data collection without changing the tool body or adding another groove. Within the same array, there are increased measurement combinations. Adding a transmitter adds at least five more measurements instead of just doubling the number of measurements. Furthermore, verification measurements are disclosed by symmetrical placement of the pairs of antennas, placement of transmitters, and selection of differential receivers. The system can increase precision and reliability without any adjustment to the tool body.

The foregoing disclosure and description of the invention is illustrative and explanatory thereof. Various changes in the details of the illustrated structures, construction and method can be made without departing from the true spirit of the invention.

We claim:

1. A system for measuring electric resistivity around a borehole, said system comprising:
a tool body having a generally cylindrical shape;
at least one transmitter means mounted on said tool body at a first transmitter position;
an array of receiver means mounted on said tool body at a set distance from said at least one transmitter means; and
a processing means for calculating electric resistivity connected to said at least one transmitter means and said array of receiver means,
wherein said first transmitter position is set a first distance from said array so as to produce a first set of at least five different measurement combinations with said array.

2. The system for measuring electric resistivity, according to claim 1, further comprising:
at least one more transmitter means mounted on said tool body at a second transmitter position, said second transmitter position being set at a second distance from said array so as to produce a second set of five different measurement combinations with said array.

3. The system for measuring electric resistivity, according to claim 2, wherein said first distance between said first transmitter position and said array and said second distance between said second transmitter position and said array is symmetrical to said array.

4. The system for measuring electric resistivity, according to claim 3, wherein said first set of five different measurement combinations verify said second set of five different measurement combinations.

5. The system for measuring electric resistivity, according to claim 2, wherein said first distance between said first transmitter position and said array and said second distance between said second transmitter position and said array is asymmetrical to said array.

6. The system for measuring electric resistivity, according to claim 1, wherein said array comprises:
a first pair of receiver means mounted on said tool body at a first pair position, each receiver means being comprised of an antenna; and
a second pair of receiver means mounted on said tool body at a second pair position,
wherein said first pair of receiver means is comprised of a first antenna and a third antenna, and wherein said second pair of receiver means is comprised of a second antenna and a fourth antenna.

7. The system for measuring electric resistivity, according to claim 6, wherein said first pair position is equidistant between the first antenna and the third antenna.

8. The system for measuring electric resistivity, according to claim 7,wherein said second pair position being equidistant between the second antenna and the fourth antenna.

9. The system for measuring electric resistivity, according to claim 6, wherein distance between the first antenna and the third antenna is less than distance between the first antenna and the second antenna of the second pair.

10. The system for measuring electric resistivity, according to claim 6, wherein the first antenna is adjacent the second antenna, the first antenna being between the second antenna and the third antenna, the second antenna being between the fourth antenna and the first antenna.

11. The system for measuring electric resistivity, according to claim 6, wherein said first set of five different measurement combinations comprises:
an initial measurement determined by said first antenna and said second antenna;
a first compensated measurement determined by said first antenna and said third antenna of said first pair;
a second compensated measurement determined by said second antenna and said fourth antenna of said second pair;
a first middle compensated measurement determined by said second antenna and said third antenna; and a a second middle compensated measurement determined by said first antenna and said fourth antenna,
wherein said first transmitter position, said first pair position and said second pair position are selected for distance between said second antenna and said third antenna being greater than distance from said first antenna to said second antenna and distance from said first antenna to said third antenna, said distance between said second antenna and said third antenna being less than distance from said third antenna to said fourth antenna.

12. The system for measuring electric resistivity, according to claim 6, wherein said first set of five different measurement combinations comprises:
an initial measurement determined by said first antenna and said second antenna;
a first compensated measurement determined by said first antenna and said third antenna of said first pair;
a second compensated measurement determined by said second antenna and said fourth antenna of said second pair;
a first middle compensated measurement determined by said second antenna and said third antenna; and a a second middle compensated measurement determined by said first antenna and said fourth antenna,
wherein said first transmitter position, said first pair position and said second pair position are selected for distance between said first antenna and said fourth antenna being greater than distance from said first antenna to said second antenna and distance from said second antenna to said fourth antenna, said distance between said first antenna and said fourth antenna being less than distance from said third antenna to said fourth antenna.

13. The system for measuring electric resistivity, according to claim 6, further comprising:
a second transmitter means mounted on said tool body at a second transmitter position on a side of the first pair and the second pair opposite from the first transmitter means, said second transmitter means being symmetrical to said first transmitter means relative to a midpoint between the first pair and the second pair; and
a processing means calculating measurements from second second transmitter means as back up to measurements from the first transmitter means, said second transmitter means adding a second set of five different measurement combinations from said array.

14. The system for measuring electric resistivity, according to claim 13, further comprising:
a third transmitter means mounted on said tool body at a third transmitter position on a same side of the first pair and the second pair as the first transmitter means, said third transmitter means being further away from the midpoint between the first pair and the second pair than the first transmitter means,
wherein said processing means calculates measurements from said third transmitter means with lower resolution and greater depth investigation as measurements from said first transmitter means, said third transmitter means adding a third set of five different measurement combinations from said array.

15. The system for measuring electric resistivity, according to claim 14, further comprising:
a fourth transmitter means mounted on said tool body at a fourth transmitter position on a side of the first pair and the second pair opposite from said first transmitter means and said third transmitter means and same side as said second transmitter means, said fourth transmitter means being symmetrical to the third transmitter means relative to a midpoint between the first pair and the second pair,
wherein said processing means calculates measurements from said fourth transmitter means as back up to measurements from said third transmitter means, said fourth transmitter means adding a fourth set of five different measurement combinations from said array.

16. A method for measuring electric resistivity, the method comprising the steps of:
assembling a downhole tool by mounting the at least one transmitter on a tool body at the first transmitter position, said at least one transmitter being a first transmitter;
mounting an array comprised of a first pair of receivers on said tool body at a first pair position and a second pair of receivers on said tool body at a second pair position;
connecting a processor for calculating electric resistivity; and
producing a first set of at least five different measurement combinations with said array based on positions of each receiver within said array,
wherein each receiver is comprised of an antenna, said array being comprised of four antennas, wherein distance within a pair of receivers is smaller than distance between receivers of different pairs, wherein distance with a pair of receivers is identical for both pairs, wherein distance between adjacent receivers of different pairs is fixed, while distance between receivers in a pair may be varied based on diameter of said tool body, and wherein symmetrical placement of pairs relative to said first transmitter provides for additional verification measurements.

17. The method for measuring electric resistivity, according to claim 16, wherein said first pair of receiver means is comprised of a first antenna and a third antenna, and wherein said second pair of receiver means is comprised of a second antenna and a fourth antenna, the method further comprising the step of:
verifying said first set of at least five different measurement combinations, said first antenna and said second antenna producing said first set of at least five different measurement combination with said processor, said third antenna and said fourth antenna verifying said first set of at least five different measurement combinations with greater depth investigation and lower resolution.

18. The method for measuring electric resistivity, according to claim 16, wherein said first pair of receiver means is comprised of a first antenna and a third antenna, and wherein said second pair of receiver means is comprised of a second antenna and a fourth antenna, the method further comprising the step of:
verifying said first set of at least five different measurement combinations, said first antenna and said second antenna producing said first set of at least five different measurement combinations, said first antenna and said third antenna verifying said first set of at least five different measurement combinations with lower depth investigation and greater resolution.

19. The method for measuring electric resistivity, according to claim 18, the step of verifying further comprising:
verifying said first set of at least five different measurement combinations with lower depth investigation and greater resolution by said first antenna and said third antenna with said second antenna and said fourth antenna.

20. The method for measuring electric resistivity, according to claim 16, wherein said first pair of receiver means is comprised of a first antenna and a third antenna, and wherein said second pair of receiver means is comprised of a second antenna and a fourth antenna, the method further comprising the step of:
verifying said first set of at least five different measurement combinations, said first antenna and said second antenna producing said first set of at least five different measurement combinations, said first antenna and said fourth antenna verifying said first set of at least five different measurement combinations at a middle depth investigation and middle resolution determined by the first transmitter position, the first pair position, and the second pair position; and
verifying said middle depth investigation and said middle resolution of said first antenna and said third antenna with said second antenna and said fourth antenna.
